(19) United States
(12) Patent Application Publication
(10) Pub. No.: US 2023/0313943 A1
(43) Pub. Date: Oct. 5, 2023

(54) ANCHOR UNIT, STRUCTURE AND METHOD FOR MANUFACTURING A STRUCTURE

(71) Applicants: Henning Hager, Alsbach-Hähnlein (DE); Dominik Hiesch, Babenhausen (DE)

(72) Inventor: Henning Hager, Alsbach-Hähnlein (DE)

(73) Assignees: Henning Hager, Alsbach-Hähnlein (DE); Dominik Hiesch, Babenhausen (DE)

(21) Appl. No.: 18/194,732

(22) Filed: Apr. 3, 2023

(30) Foreign Application Priority Data
Apr. 4, 2022 (DE) 102022107996.1

(51) Int. Cl. F16M 13/02

(52) U.S. Cl. CPC F16M 13/027

(57) ABSTRACT

An anchor unit that is fully or at least partially embedded in a structure, such as a ceiling, in a structural element made from a casting compound of the structure and/or permanently fixed or fixable in a form-fitting and/or force-locked manner, with at least one anchor head which includes at least one holding fixture which is accessible from the outside and into which a fixing means can be inserted and fixed therein, and with at least one rod-shaped or wire-shaped anchoring element which is fixed to the anchor head, which is inelastic along its longitudinal direction and flexibly bendable transversely to its longitudinal direction. The anchor head in the permanently arranged state is arranged between a free surface of the structural element and a reinforcement means, of which there is at least one, arranged in the structural element arranged and the holding fixture is freely accessible from the outside.

### CROSS-REFERENCE TO RELATED APPLICATIONS

This application claims the benefit of German application DE 10 2022 107 996.1, filed Apr. 4, 2022, which is incorporated by reference.

The invention relates to an anchor unit, a structure with such an anchor unit and a method for manufacturing such a structure.

### BACKGROUND

In the manufacture of buildings, a known method is to produce structures, such as a ceiling, from a casting compound such as concrete. Reinforcement means can be arranged in the structural element produced from the casting compound.

Fixing functional elements, such as pipes or ventilation systems, to a ceiling is known from the current state of the art. For this purpose, holding fixtures are added to the structure designed as a ceiling by creating bores, into which the functional elements can be fixed. In this context, the fact that a structure that has already been produced by curing a casting material then needs to be processed by removing some of the material, e.g., by drilling, has proven to be disadvantageous and cumbersome.

Arranging anchor units on a formwork means when producing a concrete ceiling and fixing them to one or more reinforcement means is known from the state of the art. This proves to be time-consuming and cumbersome.

### SUMMARY

An object of an embodiment of the invention is to propose an anchor unit, a structure with such an anchor unit and a method for producing such a structure that can be placed in a manner which saves time, can be positioned in any required position and cannot be detached from the structure.

This object is achieved with an anchor unit in a structure, such as a ceiling, that can be fixed or is attached, in its entirety or at least in sections, to a structural element of the structure made of a casting compound, such as concrete, in a non-detachable, form-fitting and/or force-locked manner, with at least one anchor head which includes at least one holding fixture accessible from the outside, into which a fixing means can be inserted and fixed therein, and with at least one rod-shaped or wire-shaped anchoring element that is fixed to the anchor head, which is inelastic along its longitudinal direction and flexibly bendable transversely to its longitudinal direction. The anchor head, in the non-detachable arranged state, is arranged between a free surface of the structural element and at least one reinforcement means arranged in the structural element, and the holding fixture is freely accessible from the outside.

Due to the fact that the anchor unit includes an anchor head, which is arranged between a free surface of the structural element and at least one reinforcement means arranged in the structural element, the anchor unit can be arranged at any point of the structure without the anchor head colliding with the reinforcement means during arrangement.

As the anchor unit includes at least one anchoring element fixed to the anchor head, which is inelastic along its longitudinal direction and flexibly bendable transversely to its longitudinal direction, the load-bearing capacity of the anchor unit can be increased and the anchoring element can be bent flexibly in such a way that it can, for example, be guided around the reinforcement means.

As a result, the anchor unit can be arranged at any desired location in the structure despite the provision of anchoring elements, and the time required to arrange the anchor unit is also reduced.

The flexibility of the anchoring elements also prevents the anchor head from detaching from its fastening surface when forces are applied, such as external loads as a result of filling in the casting compound, in particular during a concreting process. Such forces can be transmitted, for example, when inadvertently bumping into a concrete vibrator.

The anchoring element is inelastic along its longitudinal direction and therefore supports the anchor head in a load-bearing manner.

The anchor head and anchoring element can each be permanently fixed to the structural element in a form-fitting or force-locked manner.

At least one of the anchoring elements, of which there is at least one, can be fixed on a side of the anchor head facing away from the holding fixture. As an alternative or in addition to this, at least one of the anchoring elements, of which there is at least one, can be fixed on a side surface of the anchor head running transversely or obliquely to the surface including the holding fixture.

If the anchor unit in the structural element of the structure can be fixed or is fixed in a non-detachable, form-fitting and/or force-locked manner, the anchor unit is, for example, encapsulated by the casting compound and the casting compound has hardened.

The anchoring element(s), of which there is at least one, can be flexible transversely to its longitudinal direction. In such a case, for example, it may be displaced by the casting compound when pouring in the casting compound to produce the structural element and its arrangement. If a plurality of anchoring elements is provided, the anchor unit with the plurality of anchoring elements can be arranged in the structural element in a root-like manner.

In one embodiment of the anchor unit, it has proven to be favourable if at least one of the anchoring elements, of which there is at least one, is flexibly bendable transversely to its longitudinal direction when a certain force is exceeded and can be fixed in a plurality of curved configurations, in particular in a dimensionally stable manner.

If at least one of the anchoring elements, of which there is at least one, is flexibly bendable transversely to its longitudinal direction when a certain force is exceeded, the anchor unit can remain in a selected shape, even if casting compound flows past the anchor unit and/or if a person accidentally touches the anchor unit.

The determined or certain force preferably includes a force that can be transmitted manually by a person and that is greater than a force transferred to the anchoring element by filling in casting compound.

In principle, it is conceivable that at least one of the anchoring elements, of which there is at least one, is bent in such a way that it can be arranged entirely below a reinforcement means. In embodiments of the anchor unit, it has proven to be favourable if at least one of the anchoring elements, of which there is at least one, overlaps or penetrates (when viewed transversely to the free surface of the structural element) the reinforcement means, of which there is at least one, through an opening in the reinforcement means, of which there is at least one, or through a reinforcement-free space in the structural element.

The anchor head can have a height of 1 to 5 cm, in particular 1.5 to 4 cm, in particular 1.5 to 2.5 cm, transversely to the free surface. At least one of the anchoring elements, of which there is at least one, can have such a length with respect to its longitudinal extension that it protrudes through at least the plane of the reinforcement means that is furthest from the free surface.

Furthermore, embodiments of the anchor unit are conceivable in which at least one of the anchoring elements, of which there is at least one, is fixed to the anchor head in a detachable manner, in particular by screwing, or in a non-detachable manner, in particular by welding, soldering, riveting or gluing.

If at least one of the anchoring elements, of which there is at least one, is fixed in a detachable manner, in particular by screwing, on or in the anchor head, anchor units can be equipped with one and the same anchor head, each with different anchoring elements. As a result, the anchor unit can be adapted to the respective installation position with regard to the expected load to be absorbed.

If at least one of the anchoring elements, of which there is at least one, is non-detachable, in particular by means of welding, soldering, riveting or gluing, on or in the anchor head, the anchor unit can be designed to be at least partially preassembled.

In a development of the anchor unit, it is favourable if at least one of the anchoring elements, of which there is at least one, is a wire or a rod with a diameter of 1 mm to 4 mm, in particular 2 mm to 2.5 mm, and a length of 30 mm to 150 mm, in particular 100 mm.

In principle, it is conceivable that at least one of the anchoring elements, of which there is at least one, can absorb forces and loads exclusively through its form-fitting and/or force-locked arrangement within the structural element. In order to further improve load absorption by the anchor unit, the anchor unit includes at least one plate means, which is arranged on an end of at least one of the anchoring elements, of which there is at least one, opposite the anchor head and which has a diameter transverse to the longitudinal direction of the anchoring element that is larger than the diameter of the anchoring element.

The plate means creates an additional frictional connection, in particular a rear grip, of the anchor unit with the structural element, as a result of which the loads that can be absorbed by the anchor unit are further increased.

In a further development of the last-mentioned embodiment, it proves to be favourable if the plate means is fixed rigidly to the anchoring element and/or if the plate means is fixed in a detachable or non-detachable manner to the anchoring element.

In principle, it is conceivable that the anchor unit includes a single anchoring element. In an exemplary embodiment of the anchor unit, it has proven to be favourable if the anchor unit includes at least two anchoring elements that are fixed to the anchor head and on each of which a plate means is arranged on the end facing away from the anchor head.

If the anchor unit includes several anchoring elements, these can be arranged symmetrically on the anchor head. Furthermore, these can be fixed at any point of the anchor head, for example on a surface facing away from and opposite the free surface or on a side surface.

In order to fix installation means, such as cables or air ducts, to the structure, it has proven to be favourable if the holding fixture of the anchor head has an internally threaded section, in which the fixing means can be fixed with an externally threaded section, and/or which includes at least one rear-gripping section formed transversely to the direction of insertion, into which the fixing means can be fixed with a projecting section, forming a rear grip.

In such a case, the fixing means can be used to fix an installation unit, such as a cable duct, air duct or the like, to the structure in a simple manner by means of the anchor unit.

If the holding fixture of the anchor head includes an internally threaded section, the fixing means can be screwed into the internally threaded section with its externally threaded section.

If the holding fixture includes a rear-gripping section formed transversely to the direction of insertion, the fixing means can be fixed in the holding fixture in a simple manner by means of clipping or a bayonet catch.

In order to further increase the possible load-bearing capacity using the anchor unit, it proves to be favourable if the anchor head includes a surface section with increased surface roughness transversely to the free surface of the structural element, which includes a large number of elevations and depressions, in particular if the surface section with increased surface roughness includes an externally threaded section and/or a knurled section.

This allows the frictional connection or force-locking connection between the anchor head and the structural element to be increased and the loads that can be absorbed by the anchor unit are increased.

In order to ensure that the anchor unit is fixed in place when the structure is formed, in particular when the casting compound flows around it, one exemplary embodiment of the anchor unit includes at least one positioning element that can be fixed to a formwork onto which the casting compound, such as concrete, can be cast onto the structural element of the structure in order to manufacture the structural element, and by means of which the anchor head is fixed against movement parallel to the surface of the formwork.

The positioning element can, for example, be permanently attached to the formwork, for example by means of gluing, nailing, screwing, or riveting. When the casting compound has hardened and forms the structural element, the positioning element can be removable together with the formwork, whereby the anchor head with its holding fixture is accessible from the outside. In such a case, the positioning element can be fixed in place on the formwork at least until the casting compound has hardened, in particular until the end of a setting process if the casting compound includes concrete Furthermore, the positioning element can remain on the anchor head after removal.

In addition, the anchor element can be arranged in the holding fixture of the anchor head with a force-locked or friction-locked fit. As a result, a release force must be reached or exceeded in order to move the anchor head transversely to the surface of the formwork. The release force is in a range above the forces to be expected when the casting compound hardens or when it is touched unintentionally. The release force is in a range that allows manual release of the positioning element from the anchor head.

It has proven to be favourable if the positioning element includes a spigot element on which the anchor head with the holding fixture accommodating the spigot element can be arranged, wherein the spigot element has a cross-section designed to correspond to, in particular complement, the holding fixture, and/or if the positioning element includes a receiving area on a side facing away from the formwork to which the spigot element can be detachably fixed to the anchor head.

The spigot element can include an elastically compressible material, in particular plastic or elastomer.

In a further development, the spigot element can be arranged on a disk element, on which the spigot element is fixed and on which the anchor head rests with an end face including the holding fixture. The disk element can include a transparent material, such as plastic, which facilitates positioning on the formwork.

The receiving area can, for example, include a depression in the positioning element, into which the anchor head can be inserted. The depression can include a cross-section designed to correspond to, in particular complement, the anchor head. In such a case, the positioning element can be designed in the manner of a perforated disk or sleeve.

If the positioning element includes a spigot element, this can be arranged in the holding fixture of the anchor head with a frictional or force-locking fit, as a result of which the anchor head is fixed at least against moving parallel to the surface of the formwork. If the spigot element includes an elastically compressible material, a frictional or force-locking connection can be formed in a simple manner when the spigot element is arranged in the holding fixture of the anchor head, whereby the anchor head is held against movement transversely to the formwork until a release force is reached or exceeded.

It is conceivable that several anchor units are installed in a structure. In doing so, different functionalities can be assigned to different anchor units. For example, a cable or wire can be attached to one anchor unit and an air duct or the like to another anchor unit. In order to facilitate management and assignment of an anchor unit, it proves to be favourable if the anchor unit includes at least one optically, electronically or magnetically perceptible information element, such as a bar code or RFID chip, which is arranged or identifiable on a surface facing the free surface of the structural element and which can be used to assign information in a computing unit and distinguish one anchor unit from other anchor units.

If the information element includes a bar code, this can be detected optically when the anchor unit is installed. In such a case, an anchor unit can be scanned and assigned a function, for example using a scanner. If the anchor unit includes an RFID chip, the activities described above can also be carried out electronically or magnetically. Furthermore, in such a case, the anchor unit can also be identified or assigned if there is no immediately free optical line of sight.

In addition, the object is achieved by a structure, such as a ceiling, with at least one structural element made from a casting compound, such as concrete, with at least one reinforcement means that is arranged within the structural element, and with at least one anchor unit with at least one of the aforementioned features which is arranged in the structural element in its entirety or at least in sections and is permanently attached, the anchor unit having at least one anchor head which is arranged between a free surface of the structural element and the reinforcement means and which includes at least one holding fixture that is accessible from the outside on the side of the free surface of the structure and in which a fixing means can be inserted and fixed, and whereby the anchor unit includes at least one rod-shaped or wire-shaped anchoring element.

In addition, the object is achieved by a method for producing a structure with at least one of the features mentioned above with an anchor unit with at least one of the features mentioned above, characterised by the steps:
a. Laying out a formwork and arranging at least one reinforcement means at a distance from the formwork;
b. Arranging at least one anchor unit on the formwork, in which at least one of the anchoring elements, of which there is at least one, is flexibly bendable transversely to its longitudinal direction when a certain force acting on it is exceeded and can be fixed in a plurality of curved configurations, in particular in a dimensionally stable state, and/or in which at least one of the anchoring elements, of which there is at least one, is channelled towards the reinforcement means by bending in an arrangement overlapping with the reinforcement means;
c. Placing the casting compound on the formwork;
d. Removing the formwork after the casting compound has hardened.

Furthermore, it has proven to be favourable if a positioning element is fixed to the formwork after a formwork has been laid out and before the reinforcement means, of which there is at least one, has been arranged and if the arrangement of the anchor unit, of which there is at least one, on the formwork includes the arrangement of the anchor head in the receiving area of the positioning element.

The position of the anchor unit can be marked on the formwork before the positioning element is arranged. The subsequent position of the anchor unit in the completed structure can then be accurately specified.

Further features, details and advantages of the invention are specified in the appended patent claims, the graphic representation and the following description of preferred embodiments of the anchor unit, the structure and the method.

### BRIEF DESCRIPTION OF THE DRAWINGS

The drawings illustrate the following:

A sectional view through a first exemplary embodiment of the structure with an anchor unit according to the invention;

A sectional view through a second exemplary embodiment of the anchor unit in an arrangement for forming the structure;

FIG. 3A sectional view through a third exemplary embodiment of the anchor unit in an arrangement for forming the structure;

FIG. 4A sectional view through a fourth exemplary embodiment of the anchor unit in an arrangement for forming the structure;

FIG. 5A schematic flowchart of an exemplary embodiment of the method.

### DETAILED DESCRIPTION

FIG. 1 shows a first exemplary embodiment of a structure, such as a ceiling, which is generally referred to as reference sign 2. Structure 2 includes a structural element 4 which is made from a casting compound such as concrete. At least one reinforcement means 6 is arranged in the structural element 4.

In addition, the structure 2 includes an anchor unit 8 which is fixed in a non-detachable, form-fitting and/or force-locked manner in the structural element 4. The anchor unit 8 includes an anchor head 10 that includes at least one holding fixture 12, which is accessible from the outside. A fixing means can be inserted into the holding fixture 12 and fixed therein.

In addition, the exemplary embodiment according to FIG. 1 shows the anchor unit 8 with three rod-shaped or wire-shaped anchoring elements 14 which are fixed to the anchor head 10 and which are inelastic along their longitudinal direction and flexible and bendable transversely to their longitudinal direction. At the ends of the anchoring elements 14 opposite the anchor head 10, the anchor unit 8 includes the plate means 16. The plate means 16 may be a circular, octagonal, pentagonal, or rectangular plate-like structure.

FIG. 1 shows structure 2, in which the anchor unit 8 is arranged between a free surface 18 of the structural element 4 under the reinforcement means 6. The anchoring elements 14 pass through the reinforcement means 6 via an opening in the reinforcement means 6 or through a reinforcement-free intermediate space in the structural element 4. In such a case, the anchoring elements 14 can surround the reinforcement means 6 on both sides and can be guided completely past them.

In the exemplary embodiment shown in FIG. 1, the anchor unit 8 includes an internally threaded section 20 in the area of the holding fixture 12, in which the fixing means can be fixed with an externally threaded section.

FIG. 2 shows a second exemplary embodiment of the anchor unit 8, which includes a positioning element 22. The positioning element 22 is fixed in place on a formwork 24. The casting compound, such as concrete, of the structural element 4 can be poured onto the formwork 24, as a result of which the structural element 4 is formed by curing the casting compound. On a side facing away from the formwork 24, the positioning element 22 includes a receiving area 26 in which the anchor head 10 can be detachably arranged and is fixed to prevent movement parallel to the surface of the formwork 24.

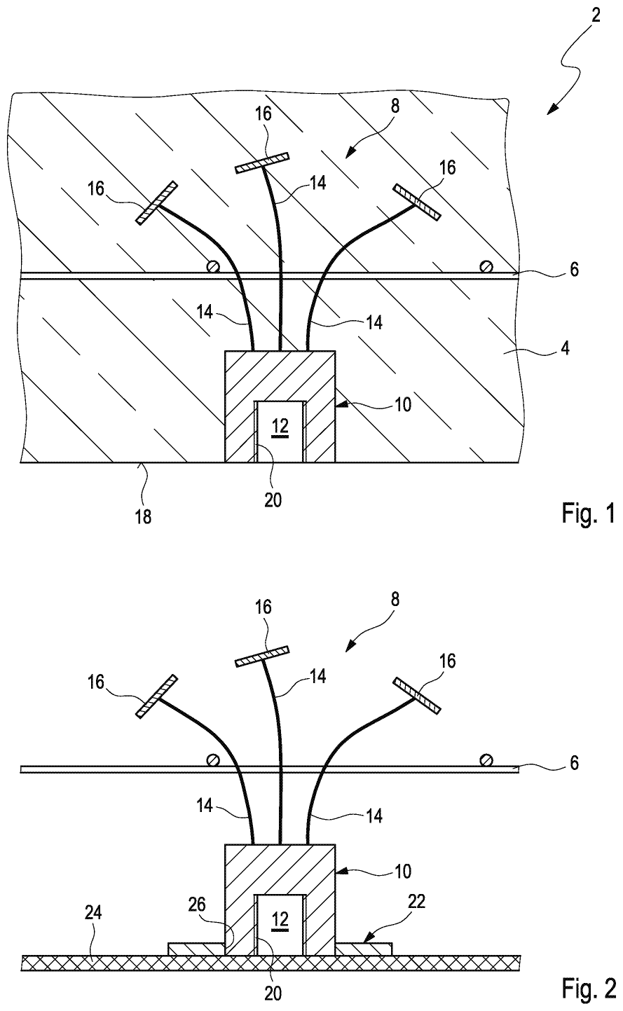

FIG. 3 shows a third exemplary embodiment of the anchor unit 8, in which the positioning element 22 includes a spigot element 28, onto which the anchor head 10 can be pushed with its holding fixture 12 and is fixed to prevent movement parallel to the surface of the formwork 24.

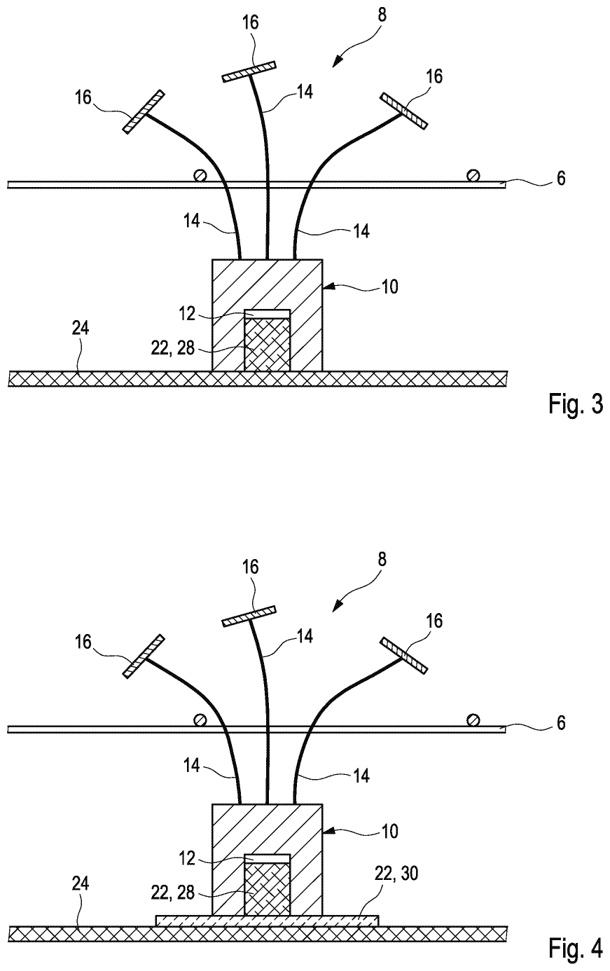

FIG. 4 shows a fourth exemplary embodiment of the anchor unit 8 in which the positioning element 22 includes a spigot element 28 and a disc element 30. The spigot element 28 is fixed to the disc element 30 and the disc element 30 to the formwork 24. The anchor head 10 can be pushed onto the spigot element with its holding fixture 12 and is fixed to prevent movement parallel to the surface of the formwork 24.

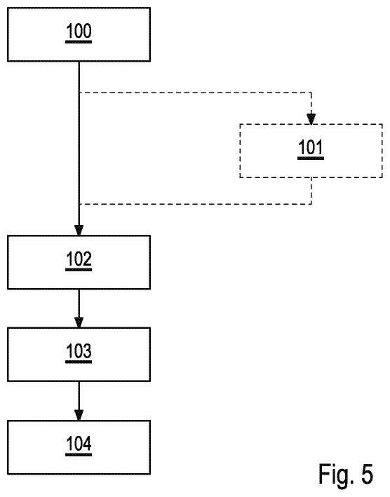

FIG. 5 shows an exemplary embodiment of a method according to the invention for producing a structure 2 according to FIG. 1. The method is described below with the aid of the representation in FIG. 2:

In a first step 100, a formwork 24 is laid out and at least one reinforcement means 6 is arranged, wherein the reinforcement means 6 are a distance from the formwork 24. The position of the structure 2 can be placed on the formwork 24, for example by marking the centre point of the anchor unit 8.

In a subsequent step 102, at least one anchor unit 8 is arranged on the formwork 24, wherein at least one of the anchoring elements 14, of which there is at least one, can be guided past the reinforcement means 6 by bending in the event of a collision between the anchoring element and the reinforcement means.

A step 101 can be included between steps 100 and 102, in which a positioning element 22 is fixed to the formwork 24. In such a case, the anchor unit 8 with the anchor head 10 is arranged in the receiving area 26 of the positioning element 22 or is pushed onto the spigot element 28 of the positioning element 22 in step 102.

In step 103, casting compound is arranged on the formwork 24 after arranging the anchor unit 8 directly or indirectly on the formwork 24. This can be done by casting.

As soon as the casting compound has hardened, the formwork 24 is removed in a subsequent step 104. Upon removal of the formwork 24, the positioning element 22 can also be removed.

The features of the invention disclosed in the description above, in the claims and in the drawing may be essential both individually and in any combination for the implementation of the invention in its various embodiments.

### LIST OF REFERENCE SIGNS

2 Structure
4 Structural element
6 Reinforcement means
8 Anchor unit
Anchor head
12 Holding fixture
14 Anchoring element
16 Plate means
18 Free surface
Internally threaded section
22 Positioning element
24 Formwork
26 Receiving area
28 Spigot element
Disk means
100-104 Process steps

1. An anchor unit, which is configured to be fixed or is fixed in a structure at least partially in sections in a structural element of the structure made from a casting compound in a non-detachable form-fitting and/or force-locked manner, comprising:
at least one anchor head, which comprises at least one holding fixture accessible from outside the structure, into which a fixing means is able to be inserted and fixed therein, and at least one rod-shaped or wire-shaped anchoring element which is fixed to the at least one anchor head, which is inelastic along a longitudinal direction and flexibly bendable transversely to the longitudinal direction,
wherein the at least one anchor head is arrangeable in a non-detachable state between a free surface of the structural element and at least one reinforcement means arranged in the structural element and the at least one holding fixture is accessible from the outside.

2. The anchor unit according to claim 1, wherein at least one of the anchoring elements is flexibly bendable transversely to the longitudinal direction when a force is exceeded and is able to be fixed in a plurality of curved configurations, in particular in a dimensionally stable manner.

3. The anchor unit according to claim 1, wherein at least one of the anchoring elements, when viewed transversely to the free surface of the structural element, overlaps or passes through the reinforcement means via an opening in the reinforcement means or through a reinforcement-free intermediate space in the structural element.

4. The anchor unit according to claim 1, wherein at least one of the anchoring elements is fixed on or in the anchor head in a detachable manner, in particular by screwing, or in a non-detachable manner, in particular by means of welding, soldering, riveting or gluing.

5. The anchor unit according to claim 1, wherein at least one of the anchoring elements comprises a wire or a rod with a diameter of 1 mm to 4 mm.

6. The anchor unit according to claim 1, wherein at least one plate means which is arranged on an end of at least one of the anchoring elements opposite the anchor head and which comprises a diameter transverse to the longitudinal direction of the anchoring element which is larger than a diameter of the anchoring element.

7. The anchor unit according to claim 6, wherein the at least one plate means is rigidly fixed to the anchoring element and/or that the at least one plate means is detachably or permanently fixed to the anchoring element.

8. The anchor unit according to claim 1, wherein the at least one anchoring element includes at least three anchoring elements which are fixed to the anchor head and on each of which a plate means are arranged at an end facing away from the anchor head.

9. The anchor unit according to claim 1, wherein the at least one holding fixture of the anchor head comprises an internally threaded section in which the fixing means is able to be fixed with an externally threaded section, and/or at least one rear-gripping section formed transversely to a direction of insertion, in which the fixing means is able to be fixed with a projecting section forming a rear grip.

10. The anchor unit according to claim 1, wherein the at least one anchor head on a transverse to the free surface of the structural element comprises a surface section with increased surface roughness, which comprises a large number of elevations and depressions, in particular that the surface section with increased surface roughness comprises an externally threaded section and/or a knurled section.

11. The anchor unit according to claim 1, wherein at least one positioning element which is able to be fixed to a formwork, onto which the casting compound of the structural element of the structure is able to be cast in order to produce the structural element, wherein the anchor head is fixed to prevent movement parallel to a surface of the formwork.

12. The anchor unit according to claim 11, wherein the positioning element comprises a spigot element on which the anchor head with the holding fixture is able to be arranged to receive the spigot element, wherein the spigot element comprises a cross-section corresponding to, and in particular complementing, the holding fixture, and/or wherein the positioning element comprises a receiving area on a side facing away from the formwork, in which the anchor head is able to be detachably arranged.

13. The anchor unit according to claim 1, wherein at least one optically, electronically or magnetically perceptible information element, which is arranged or identifiable on a surface facing the free surface of the structural element, is provided through which information is able to be assigned in a computing unit and through which one anchor unit is able to be distinguished from other anchor units.

14. A structure comprising:
at least one structural element made from a casting compound;
at least one reinforcement means that is arranged inside the structural element; and
at least one anchor unit according to claim 1, which is arranged in the structural element at least partially in sections and permanently attached,
the anchor unit having the at least one anchor head which is located between a free surface of the structural element and the reinforcement means and which comprises the at least one holding fixture which is accessible from the outside on the side of the free surface of the structure and into which a fixing means is able to be inserted and fixed therein, and wherein the anchor unit comprises at least one rod-shaped or wire-shaped anchoring element.

15. A method for the production of structures according to claim 14, the method comprising the steps:
laying out of a formwork and arrangement of at least one reinforcement means at a distance from the formwork;
arranging of at least one anchor unit on the formwork, wherein at least one of the anchoring elements is flexibly bendable transversely to a longitudinal direction when a force acting on it is exceeded and is able to be fixed in a plurality of curved configurations, in particular in a dimensionally stable manner, and/or wherein at least one of the anchoring elements is guided past the reinforcement means by bending in an arrangement overlapping with the reinforcement means;
placing of the casting compound on the formwork; and
removing of the formwork after the casting compound has hardened.

16. The method according to claim 15, wherein after the formwork has been laid out and the reinforcement means has been arranged, a positioning element is fixed to the formwork and in that the arrangement of the anchor unit on the formwork comprises an arrangement of the anchor head in the receiving area of the positioning element.
